(19) United States
(12) Patent Application Publication
(10) Pub. No.: US 2025/0350858 A1
(43) Pub. Date: Nov. 13, 2025

(54) IMAGE PROCESSING APPARATUS, IMAGE PROCESSING METHOD, AND PROGRAM

(71) Applicant: JVCKENWOOD Corporation, Yokohama-shi (JP)

(72) Inventors: Keita HAYASHI, Yokohama-shi (JP); Tadashi ISHIWATA, Yokohama-shi (JP); Hirofumi YAMAMOTO, Yokohama-shi (JP); Keiji TSUCHIYA, Yokohama-shi (JP); Yasufumi NAKAAKI, Yokohama-shi (JP)

(21) Appl. No.: 19/277,103

(22) Filed: Jul. 22, 2025

Related U.S. Application Data
(63) Continuation of application No. PCT/JP2024/003050, filed on Jan. 31, 2024.

(30) Foreign Application Priority Data
Feb. 14, 2023 (JP) 2023-020826

(51) Int. Cl. H04N 25/53; H04N 25/20

(52) U.S. Cl. CPC H04N 25/53; H04N 25/20

(57) ABSTRACT

An image processing apparatus according to this embodiment includes: a saturation detection unit configured to detect saturation of a pixel in thermal image data; a saturation time calculation unit configured to calculate a saturation time during which the pixel is successively saturated; a positional information acquisition unit configured to acquire positional information regarding an imaging position of an infrared camera; a condition acquisition unit configured to acquire a condition of solar irradiation in the imaging position; a threshold time setting unit configured to set a threshold time in accordance with the condition of solar irradiation; a protection determination unit configured to determine whether the saturation time has exceeded the threshold time; and an instruction unit configured to send an instruction to close a shutter of the infrared camera in a case where the saturation time has exceeded the threshold time.

### CROSS REFERENCE TO RELATED APPLICATION

This application is based upon PCT/JP2024/003050, filed on Jan. 31, 2024, which is based upon and claims the benefit of priority from Japanese patent application No. 2023-20826, filed on Feb. 14, 2023, the disclosure of which is incorporated herein in its entirety by reference.

The present disclosure relates to an image processing apparatus, an image processing method, and a program.

### BACKGROUND

Patent Literature 1 discloses an image processing apparatus that processes imaging data captured by a far-infrared light sensor. In this apparatus, a saturated region where a pixel is saturated is detected. The image processing apparatus controls a dynamic range in accordance with a result of detecting the saturated region. Then opening and closing of a shutter are controlled based on the result of detecting the saturated region and setting of the dynamic range.
[Patent Literature 1] Japanese Unexamined Patent Application Publication No. 2021-110552

### SUMMARY

There is a problem, in an infrared sensor such as a microbolometer used in an infrared imaging apparatus, that if a high-intensity light is made incident, then sensor elements are degraded. For example, if sunlight is directly made incident on the infrared sensor, pixels are stuck. In this case, sensitivity of the stuck pixels is changed, which causes an image quality to be degraded.

In Patent Literature 1, the sensor elements are protected by closing the shutter. However, if the shutter is closed, images cannot be captured, which is a problem.

The present disclosure has been made in view of the aforementioned circumstances, and provides an image processing apparatus, an image processing method, and a program capable of appropriately acquiring thermal image data even when an infrared camera is protected by a shutter.

An image processing apparatus according to this embodiment includes: a thermal image data acquisition unit configured to acquire thermal image data captured by an infrared camera; a saturation detection unit configured to detect saturation of a pixel in the thermal image data; a saturation time calculation unit configured to calculate a saturation time during which the pixel is successively saturated; a positional information acquisition unit configured to acquire positional information regarding an imaging position of the infrared camera; a condition acquisition unit configured to acquire a condition of solar irradiation in the imaging position; a threshold time setting unit configured to set a threshold time in accordance with the condition of solar irradiation; a protection determination unit configured to determine whether the saturation time has exceeded the threshold time; and an instruction unit configured to send an instruction to close a shutter of the infrared camera in a case where the saturation time has exceeded the threshold time.

An image processing method according to this embodiment includes: a step of acquiring thermal image data captured by an infrared camera; a step of detecting saturation of a pixel in the thermal image data; a step of acquiring positional information regarding an imaging position of the infrared camera; a step of acquiring a condition of solar irradiation in the imaging position; a step of setting a threshold time in accordance with the condition of solar irradiation; a step of determining whether or not a saturation time during which the pixel is successively saturated has exceeded the threshold time; and a step of sending an instruction to close a shutter of the infrared camera in a case where the saturation time has exceeded the threshold time.

A program according to this embodiment is a program for causing a computer to execute an image processing method, in which the image processing method includes: a step of acquiring thermal image data captured by an infrared camera; a step of detecting saturation of a pixel in the thermal image data; a step of acquiring positional information regarding an imaging position of the infrared camera; a step of acquiring a condition of solar irradiation in the imaging position; a step of setting a threshold time in accordance with the condition of solar irradiation; a step of determining whether or not a saturation time during which the pixel is successively saturated has exceeded the threshold time; and a step of sending an instruction to close a shutter of the infrared camera in a case where the saturation time has exceeded the threshold time.

An object of the present disclosure is to provide an image processing apparatus, an image processing method, and a program capable of appropriately acquiring thermal image data even when an infrared camera is protected by a shutter.

### BRIEF DESCRIPTION OF THE DRAWINGS

FIG. 1 is a control block diagram showing a configuration of an imaging system;

FIG. 2 is a control block diagram showing a configuration of an infrared camera;

FIG. 3 is a control block diagram showing a configuration of an image processing unit;

FIG. 4 is a control block diagram showing a configuration of a determination unit;

FIG. 5 is a schematic diagram for describing a position of the sun and a determination range;

FIG. 6 is a flowchart showing an image processing method according to a first embodiment;

FIG. 7 is a control block diagram showing a configuration of a determination unit of an image processing apparatus according to a second embodiment;

FIG. 8 is a flowchart showing an image processing method according to the second embodiment;

FIG. 9 is a control block diagram showing a configuration of a determination unit of an image processing apparatus according to a third embodiment; and

FIG. 10 is a flowchart showing an image processing method according to the third embodiment.

### DETAILED DESCRIPTION

Hereinafter, with reference to the drawings, specific embodiments to which the present disclosure is applied will be described in detail. However, the present disclosure is not limited to the following embodiments. Further, for the sake of clarification of the description, the following descriptions and drawings are simplified as appropriate.

### First Embodiment

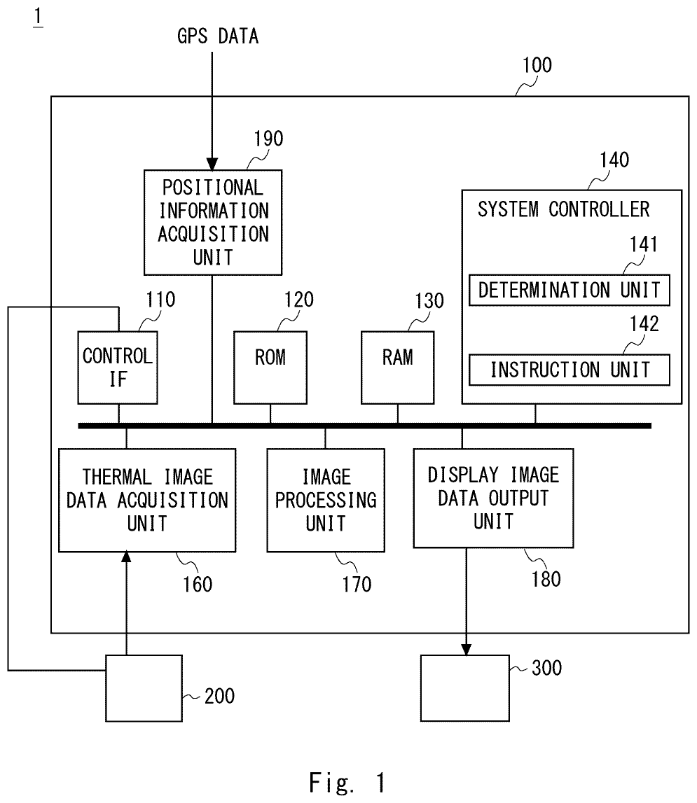

With reference to FIG. 1, an image processing apparatus and an imaging system according to this embodiment will be described. FIG. 1 is a block diagram showing a configuration of an imaging system 1. The imaging system 1 includes an image processing apparatus 100, an infrared camera 200, and a display apparatus 300. The imaging system 1 is, for example, an imaging system for a vehicle that is used in a vehicle and acquires surrounding thermal images, an imaging system used for surveillance, or the like.

In this example, an explanation will be given assuming that the imaging system 1 is an in-vehicle system mounted on a vehicle. By mounting the infrared camera 200 on the vehicle and detecting a person corresponding to a heat source object, safe driving assistance can be provided. The infrared camera 200 is mainly used to support visual safety checks at night, for example. The infrared camera 200 is effective when it is used in a case where an amount of ambient light is small at a time other than night, such as around sunrise or sunset or in a tunnel.

The infrared camera 200 captures thermal images (infrared images). The infrared camera 200 captures, for example, thermal images at 15 to 30 frames per second. For example, the infrared camera 200 captures thermal images by detecting a far-infrared ray from a subject. The infrared camera 200 is a far-infrared ray (FIR) camera capable of visualizing the far-infrared ray radiated from the object. The data of thermal images captured by the infrared camera 200 is also referred to as thermal image data (or infrared image data). The thermal image data shows a temperature distribution of an imaging range of the infrared camera 200.

The infrared camera 200 captures images in front of or around a vehicle. The infrared camera 200 outputs thermal image data to the image processing apparatus 100. Note that the thermal image data input from the infrared camera 200 to the image processing apparatus 100 is also referred to as input thermal image data. The thermal image data indicates thermal image data captured by the infrared camera. The configuration of the infrared camera 200 will be described later.

The image processing apparatus 100 generates display image data by performing image processing on the input thermal image data. For example, the image processing apparatus 100 performs various processing such as correction of pixel variation in the infrared camera 200 and noise removal caused by changes in characteristics over time. Further, the image processing apparatus 100 functions as a control apparatus for controlling the infrared camera 200.

The image processing apparatus 100 outputs display image data on which image processing has been performed to the display apparatus 300. The display image data on which image processing has been performed by the image processing apparatus 100 and which is output to the display apparatus 300 is also referred to as output thermal image data. That is, the input thermal image data is data before being processed by the image processing apparatus 100, and the output thermal image data is data after being processed by the image processing apparatus 100.

The display apparatus 300 includes a liquid crystal display or the like for displaying the display image data. The display apparatus 300 displays the display image data on which image processing has been performed in the image processing apparatus 100. Accordingly, the display apparatus 300 can display a more accurate temperature distribution.

The image processing apparatus 100 includes a control interface (IF) 110, a Read Only Memory (ROM) 120, a Random Access Memory (RAM) 130, a system controller 140, a thermal image data acquisition unit 160, an image processing unit 170, a display image data output unit 180, and a positional information acquisition unit 190.

The thermal image data acquisition unit 160 acquires the thermal image data captured by the infrared camera 200. For example, the thermal image data acquisition unit 160 includes an interface (IF) for receiving the thermal image data from the infrared camera 200. Note that the interface between the thermal image data acquisition unit 160 and the infrared camera 200 may either be a wired connection or a wireless connection.

The ROM 120 stores a control program for controlling the image processing apparatus 100 and various kinds of parameters. The ROM 120 stores, for example, an image processing program executed by the image processing unit 170. Further, the ROM 120 stores a system control program executed by the system controller 140.

The RAM 130 stores various kinds of programs, parameters or the like used for execution thereof, and the like. The RAM 130 further stores calculation data in the image processing unit 170, and the like.

The system controller 140 controls the entire imaging system 1. The system controller 140 includes a processor such as a Central Processing Unit (CPU). The processor of the system controller 140 executes the control program, whereby the entire system can be controlled.

The system controller 140 includes a determination unit 141 and an instruction unit 142. The determination unit 141 determines whether or not to protect the infrared camera 200. The processing in the determination unit 141 will be described later. The instruction unit 142 outputs an instruction for closing the shutter of the infrared camera 200. That is, the instruction unit 142 outputs a control signal for opening and closing the shutter.

The control IF 110 is an interface for controlling the infrared camera 200. For example, the instruction unit 142 outputs a control signal for opening and closing the shutter of the infrared camera 200 via the control IF 110. Further, the image processing apparatus 100 can transmit various kinds of signals and data to the infrared camera 200 via the control IF 110. Further, the control IF 110 can receive various kinds of signals and data from the infrared camera 200. For example, the control IF 110 acquires an environment temperature measured by a temperature sensor of the infrared camera 200.

The image processing unit 170 performs predetermined image processing on the thermal image data acquired by the thermal image data acquisition unit 160. The image processing unit 170 may include, for example, a processor for executing the image processing program. The processor of the image processing unit 170 may be a general purpose processor or a dedicated processor. The processor of the image processing unit 170 and the processor of the system controller 140 may be common. The processing in the image processing unit 170 will be described later.

The image processing unit 170 performs image processing on the input thermal image data, whereby display image data is generated. The display image data output unit 180 is an interface that outputs the display image data to the display apparatus 300. Accordingly, a user such as a driver of a vehicle can check the display image data. Accordingly, even when it is dark, such as during the night time, people and so on who are around the vehicle can be recognized.

The positional information acquisition unit 190 acquires positional information on an imaging position of the infrared camera 200. The positional information acquisition unit 190 sequentially acquires the positional information based on a positioning signal such as GPS data received by a positioning information reception unit (not shown). The positional information acquisition unit 190 acquires time-series data of the positional information. The positional information may acquire information on the imaging direction of the infrared camera 200 as the positional information. The position and the orientation of the infrared camera 200 relative to the vehicle have already been known. It is therefore possible to obtain the imaging direction of the infrared camera 200 from a traveling direction of the vehicle.

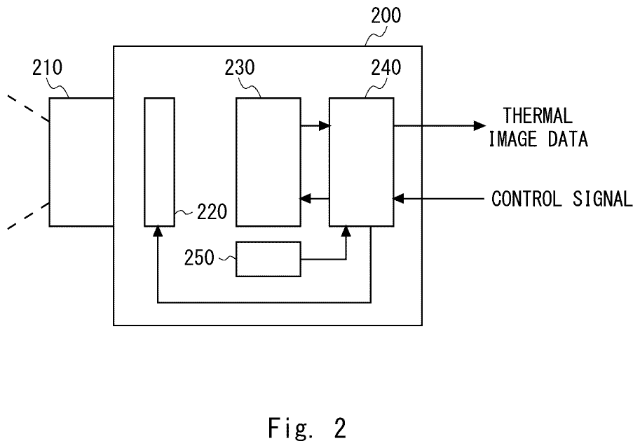

FIG. 2 is a block diagram schematically showing a detailed configuration of the infrared camera 200. The infrared camera 200 includes a lens 210, a shutter 220, a sensor 230, a transmission device 240, and a temperature sensor 250.

The lens 210 forms an image of a far-infrared light from a subject on a light receiving surface of the sensor 230. The lens 210 includes at least one lens. For example, the lens 210 may include a plurality of lenses such as a zoom lens and a focusing lens.

The sensor 230 includes a plurality of pixels. Each pixel of the sensor 230 receives an infrared light from the subject. It is therefore possible to capture a thermal image of the subject. For example, the sensor 230 includes a microbolometer for detecting a far-infrared ray. The sensor 230 includes a plurality of pixels aligned in a two-dimensional array. A detection value (detection signal) of each pixel forms a thermal image of the subject.

The transmission device 240 serves as an interface for transmitting various kinds of signals and data to the image processing apparatus 100. The transmission device 240 transmits thermal image data captured in the sensor 230 to the image processing apparatus 100. Further, the transmission device 240 receives a control signal from the image processing apparatus 100. Further, the transmission device 240 transmits lens information regarding the zoom and the focus of the lens 210.

The temperature sensor 250 measures the temperature in an environment in which the infrared camera is used. The transmission device 240 transmits the environment temperature measured by the temperature sensor 250 to the image processing apparatus 100. The environment temperature measured by the temperature sensor 250 is used for shutterless correction.

The shutter 220 is disposed on a front surface side of the sensor 230. The shutter 220 interrupts the infrared light that is made incident on the sensor 230 from the outside. The shutter 220 includes a mechanism that can be opened and closed. The shutter 220 is opened and closed by a control signal from the instruction unit 142. In a state in which the shutter 220 is closed (hereinafter this state will also be referred to as a closed state), the external light from the lens 210 is not made incident on the sensor 230. That is, in the closed state, the infrared light from the shutter 220 is made incident on the sensor 230. In a state in which the shutter 220 is opened (hereinafter this state is also referred to as an opened state), the infrared light from the lens 210 is made incident on the sensor 230. Note that the shutter 220 may make the imaging range of the sensor 230 be a thermally uniform surface. The shutter 220 may be, for example, a barrier, a cover, or the like disposed on a front surface side of the lens 210, or may be disposed between the lens 210 and the sensor 230.

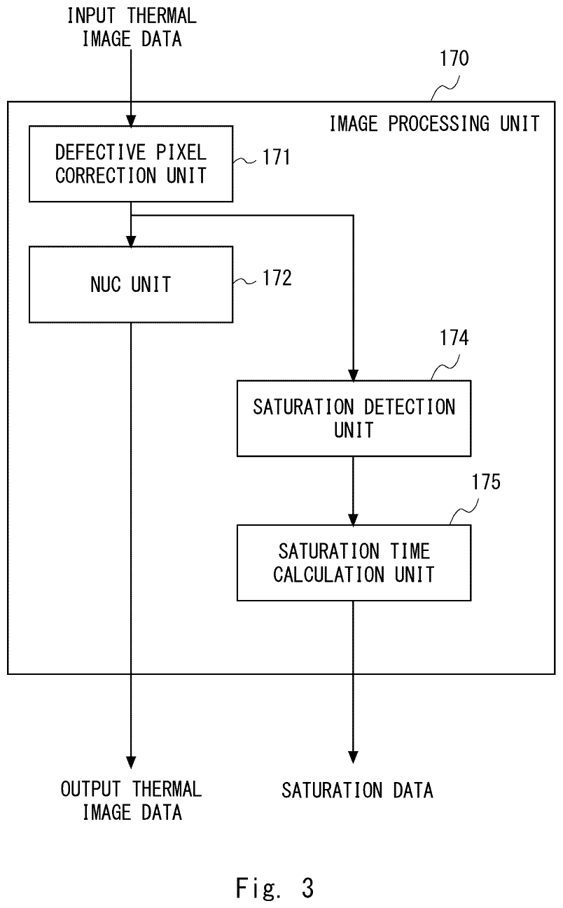

With reference to FIG. 3, a configuration of the image processing unit 170 will be described. FIG. 3 is a block diagram showing a detailed configuration of the image processing unit 170. The image processing unit 170 includes a defective pixel correction unit 171, a Non-Uniformity Correction (NUC) unit 172, a saturation detection unit 174, and a saturation time calculation unit 175. The image processing unit 170 performs predetermined processing in collaboration with the system controller 140 and the RAM 130.

The defective pixel correction unit 171 performs processing for interpolating a pixel value of a detective pixel of the sensor 230 stored in the RAM 130 in advance from pixel values in pixels around the defective pixel. The defective pixel correction unit 171 carries out the above-described interpolation processing on the input thermal image data acquired by the thermal image data acquisition unit 160, and outputs the image data for which the interpolation processing has been carried out to the NUC unit 172 and the saturation detection unit 174.

The Non-Uniformity Correction (NUC) unit 172 performs processing for correcting output variation between pixels. For example, the NUC unit 172 performs shutterless correction based on the environment temperature detected in the temperature sensor 250. Since a known method can be used for shutterless correction in the NUC unit 172, descriptions thereof will be omitted.

The saturation detection unit 174 detects saturation of a pixel in the thermal image data. The saturation detection unit 174 specifies a pixel address of the saturated pixel. The saturation detection unit 174 can thus specify a saturated region of the thermal image data where a pixel is saturated. The saturated region is a region where a saturated pixel or a substantially saturated pixel is present. The saturated pixel denotes a pixel in a state where the value of pixel data is an upper limit value. For example, in a case where a luminance level of each pixel of imaging data is expressed by 8 bits from 0 to 255, the pixel at coordinates where the luminance level has a value of 255 is referred to as the saturated pixel.

The saturation time calculation unit 175 calculates a saturation time during which a pixel is successively saturated. For example, the saturation time can be obtained from the number of frames where a certain pixel is successively saturated. Note that the saturation time may be an actual time (real time) such as seconds, or may be indicated by the number of frames, or the like. The saturation time may be a time during which a certain pixel is successively saturated or may be a time during which a saturated region including a plurality of pixels is successively saturated.

Then the image processing unit 170 outputs data indicating the presence or absence of saturation, an address of a saturated pixel, a saturated region, a saturation time, and the like to the system controller 140 as saturation data.

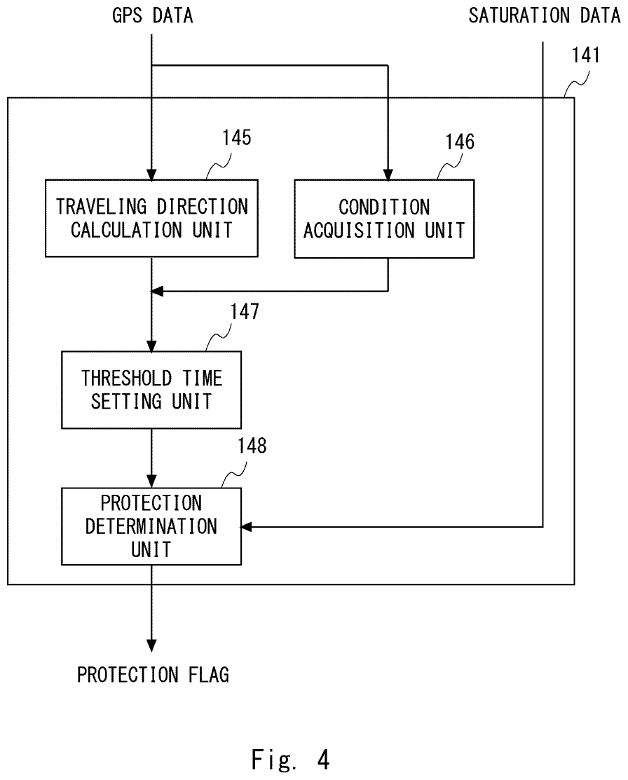

Next, with reference to FIG. 4, a configuration and processing of the determination unit 141 will be described. FIG. 4 is a control block diagram showing a configuration of the determination unit 141. The determination unit 141 includes a traveling direction calculation unit 145, a condition acquisition unit 146, a threshold time setting unit 147, and a protection determination unit 148.

The traveling direction calculation unit 145 calculates a traveling direction of an own vehicle. For example, the traveling direction calculation unit 145 calculates the traveling direction of the own vehicle from the history of GPS data. The traveling direction calculation unit 145 calculates the traveling direction of the own vehicle by comparing successively acquired positional information. Alternatively, the traveling direction calculation unit 145 may calculate the traveling direction using a gyro sensor or the like mounted on the vehicle or the infrared camera 200.

The condition acquisition unit 146 acquires a condition of solar irradiation in the imaging position. The condition acquisition unit 146 specifies the position and the orientation of the sun in the imaging position based on the date and time of imaging. The condition acquisition unit 146 can calculate the orientation of the sun from the imaging position as a condition of solar irradiation based on the calendar. The imaging position is acquired by the positional information acquisition unit 190.

The threshold time setting unit 147 sets a threshold time based on the condition of solar irradiation. The threshold time setting unit 147 calculates a determination range from the position of the sun. The determination range is a predetermined range calculated from the position of the sun. The threshold time setting unit 147 determines whether or not the traveling direction is in the determination range. The threshold time setting unit 147 sets the threshold time in accordance with the result of the determination.

The protection determination unit 148 determines whether or not to protect the sensor 230 based on the saturation data. For example, when the saturation time exceeds the threshold time, the protection determination unit 148 determines that the sensor 230 should be protected. When it is determined that the sensor 230 should be protected, the protection determination unit 148 sets a protection flag. After the protection flag is set, the instruction unit 142 shown in FIG. 1 outputs a control signal to close the shutter 220. When the saturation time during which the pixel is successively saturated exceeds a predetermined threshold time, the shutter 220 is closed and the sensor 230 is thus protected. That is, a strong light such as sunlight is not made incident on the sensor 230, whereby it is possible to prevent elements of the sensor 230 from being degraded.

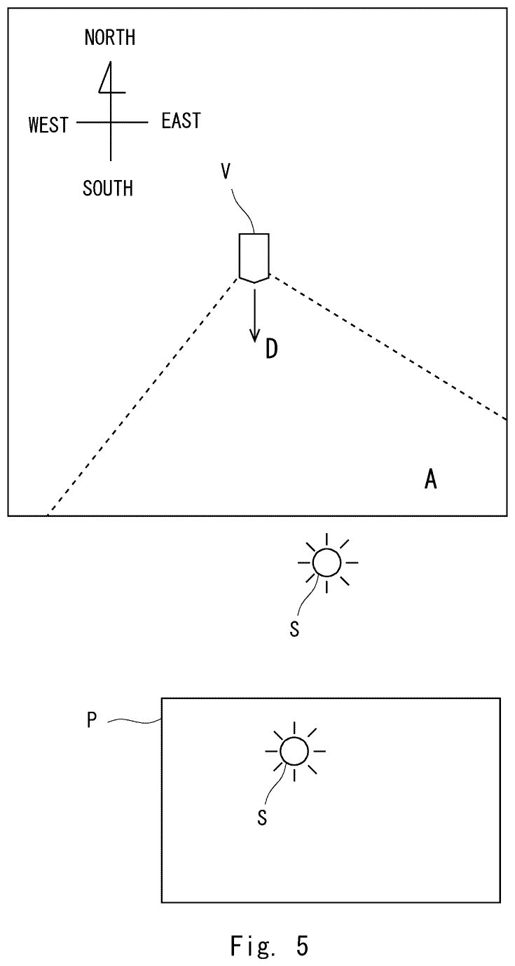

FIG. 5 schematically shows a traveling direction D of a vehicle V and the position of the sun S. The threshold time setting unit 147 sets a determination range A from the position and the like of the sun S. The determination range A is a range indicating whether or not the sunlight is directly made incident on the infrared camera 200. The threshold time set in a case in which the sunlight from the sun is directly made incident on the infrared camera 200 is different from the threshold time set in a case in which the sunlight from the sun is not directly made incident on the infrared camera 200. Since the position of the sun S is included in the determination range A, the sun S is included in a thermal image P. An extremely high-intensity far-infrared light is made incident on pixels onto which the sun S is projected.

The threshold time setting unit 147 specifies the imaging direction and the angle of view from the traveling direction of the vehicle. Then the threshold time setting unit 147 sets the determination range A from a direction included in the angle of view of the infrared camera 200. In a condition in which the imaging range (angle of view) includes the sun, it is determined that the traveling direction is in the determination range A, or in other words, the imaging direction of the infrared camera 200 is oriented toward the sun. In the condition where the imaging range (angle of view) does not include the sun, it is determined that the traveling direction is not in the determination range A, or in other words, that the imaging direction of the infrared camera 200 is not oriented toward the sun.

The determination range A can be obtained from, for example, the imaging position and the date and time of imaging (the calendar). Further, the determination range A can be obtained by using the direction in which the infrared camera 200 is installed in the vehicle, or lens information indicating the zoom or the like of the lens 210. By using these information items, the threshold time setting unit 147 can appropriately set the determination range A for determining whether or not the sun is included in the angle of view of the infrared camera 200. For example, the positional information acquisition unit 190 acquires positional information regarding the position and the orientation of the vehicle V on which the infrared camera 200 is mounted. The threshold time setting unit 147 calculates the determination range A from the positional information of the vehicle V and the condition of solar irradiation and determines whether or not the imaging direction is included in the determination range.

The threshold time setting unit 147 changes the threshold time up to the protection of the sensor 230 depending on whether the traveling direction is within the determination range A. For example, when the traveling direction is in the determination range A, the threshold time is decreased, whereas when the traveling direction is not in the determination range A, the threshold time is increased. The threshold time in the case where the traveling direction is in the determination range A is set as a first threshold time TH1. The threshold time in the case where the traveling direction is not in the determination range A is set as a second threshold time TH2. The first threshold time TH1 is shorter than the second threshold time TH2. For example, the first threshold time TH1 is 0 seconds, and the second threshold time TH2 is 5 seconds. That is, when a pixel is saturated even in one frame, the first threshold time TH1 is set so as to close the shutter 220. As a matter of course, the first threshold time TH1 and the second threshold time TH2 are not limited to these values.

As described above, the condition acquisition unit 146 acquires the condition to determine whether or not the sun is present in the imaging direction as the condition of solar irradiation. When the infrared camera 200 is oriented toward the sun, the threshold time setting unit 147 sets a short threshold time. When the pixel is saturated by sunlight being directly made incident on the infrared camera 200, the shutter 220 can be quickly closed. When the infrared camera 200 is not oriented toward the sun, the threshold time setting unit 147 sets a long threshold time. When the sunlight is not directly made incident on the infrared camera 200, the shutter 220 is closed after an elapse of the second threshold time. That is, when the pixel is saturated due to the reflected light of the sunlight, the infrared camera 200 captures images until the second threshold time is elapsed. It is therefore possible to extend the period during which images can be captured.

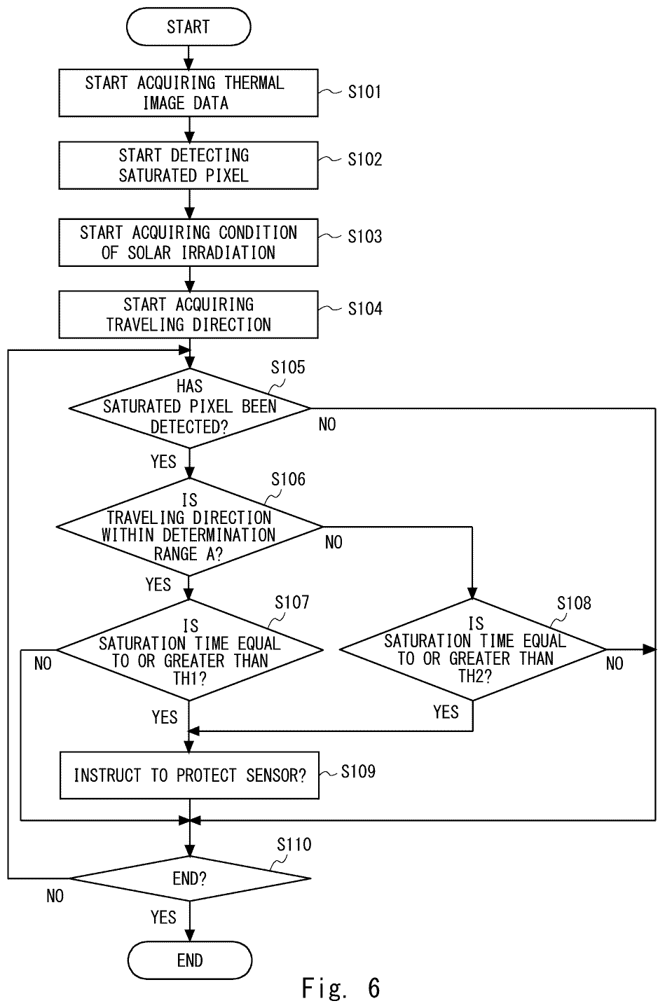

Hereinafter, with reference to FIG. 6, an image processing method according to this embodiment will be described. FIG. 6 is a flowchart showing the image processing method. The processing shown in FIG. 6 starts as the infrared camera 200 starts capturing images. Since the infrared camera 200 starts capturing images, the thermal image data acquisition unit 160 starts acquiring the thermal image data from the infrared camera 200 (Step S101). Next, the saturation detection unit 174 starts detecting a saturated pixel in the thermal image data (Step S102). That is, the pixel having the maximum value is extracted.

Next, the condition acquisition unit 146 starts acquiring the condition of solar irradiation (Step S103). For example, the condition acquisition unit 146 acquires the orientation of the sun as the condition of solar irradiation. The condition acquisition unit 146 calculates the orientation of the sun from the date and time of imaging of the thermal image data and the positional information. Next, the traveling direction calculation unit 145 starts acquiring the traveling direction (Step S104). For example, the traveling direction calculation unit 145 acquires the traveling direction from GPS data showing the positional information of the vehicle.

The processing from Steps S101 to Step S104 is continuously performed during a period in which the infrared camera 200 captures images.

Next, the saturation detection unit 174 determines whether or not saturation of a pixel in the thermal image data has been detected (S105). In other words, the saturation detection unit 174 determines whether or not a thermal image including a saturated pixel has been detected. The detection of the saturated pixel in this case can be determined when a continuous range of pixels are saturated in the thermal image data. For example, it may be determined that saturation has been detected in a case where saturated pixels in an area larger than three vertical pixels×three horizontal pixels have been detected in the thermal image based on the thermal image data. When the saturation of a pixel is not detected (NO in Step S105), the process proceeds to Step S110. When the saturation detection unit 174 has detected the saturation of the pixel (YES in Step S105), the threshold time setting unit 147 determines whether or not the traveling direction of the own vehicle is within the determination range A, that is, whether or not sunlight is directly made incident on the infrared camera 200 from the position of the sun S and the traveling direction of the own vehicle (Step S106).

When the traveling direction of the own vehicle is within the determination range A (YES in Step S106), or in other words, when the sunlight is directly made incident on the infrared camera 200, the protection determination unit 148 determines whether or not the saturation time is equal to or greater than the first threshold time TH1 (Step S107). That is, when the traveling direction of the own vehicle is within the determination range A, the threshold time setting unit 147 sets the first threshold time TH1 as the threshold time to determine whether or not to protect the sensor. When the saturation time is equal to or greater than the first threshold time TH1 (YES in Step S107), the instruction unit 142 sends an instruction to protect the sensor (Step S109). When the saturation time is not equal to or greater than the first threshold time TH1 (NO in Step S107), the process proceeds to Step S110.

When the traveling direction of the own vehicle is not within the determination range A (NO in Step S106), or in other words, when the sunlight is not directly made incident on the infrared camera 200, the protection determination unit 148 determines whether or not the saturation time is equal to or larger than the second threshold time TH2 (Step S108). That is, when the traveling direction of the own vehicle is not within the determination range A, the threshold time setting unit 147 sets the second threshold time TH2 as the threshold time to determine whether or not to protect the sensor. When the saturation time is equal to or greater than the second threshold time TH2 (YES in Step S108), the instruction unit 142 sends an instruction to protect the sensor (Step S109). When the saturation time is not equal to or greater than the second threshold time TH2 (NO in Step S108), the process proceeds to Step S110.

In Step S110, it is determined whether or not to end the processing shown in FIG. 6. The end of the processing shown in FIG. 6 means an end of image capturing in the infrared camera 200. When it is determined that the processing is ended (YES in Step S110), the processing is ended. When it is not determined that the processing is ended (NO in Step S110), the process proceeds to Step S105, and the aforementioned processing is repeatedly performed until when the processing in FIG. 6 is ended.

According to the aforementioned procedure, even when the opening and closing of the shutter 220 are controlled in order to protect elements of the sensor 230, the period until when the shutter is closed can be made longer, whereby it is possible to reduce the period during which the infrared camera 200 cannot capture images, or in other words, the period during which a person or the like corresponding to a heat source object cannot be detected, which occurs due to the shutter being closed more than necessary. If saturation of a pixel has been detected under the condition that the sunlight is not directly made incident on the infrared camera 200, the saturation of the pixel is due to a reflected light of the sunlight, or a heat source other than the sunlight. In this case, even when the saturation time is long, it does not cause much damage to the pixel. Therefore, the shutter is closed when the saturation time becomes equal to or longer than the second threshold time TH2, and the shutter does not need to be closed when the saturation time is shorter than the second threshold time TH2. In an irradiation condition in which the sunlight is directly made incident on the infrared camera 200, the threshold time setting unit 147 sets the shorter first threshold time TH1. It is therefore possible to appropriately protect the image processing apparatus 100.

The positional information acquisition unit 190 acquires positional information regarding the position and the orientation of the object on which the infrared camera 200 is mounted, whereby the positional information can be easily acquired. Then the threshold time setting unit 147 sets the determination range A based on the positional information and the direction of the sun. The threshold time setting unit 147 then determines whether or not the imaging direction is included in the determination range A. Accordingly, the threshold time setting unit 147 can set an appropriate threshold time in a simple method.

As described above, the condition acquisition unit 146 acquires the condition of solar irradiation in the imaging position by referring to the positional information. The threshold time setting unit 147 changes the threshold time in accordance with the condition of solar irradiation. The condition of solar irradiation is information indicating whether or not an extremely strong sunlight is made incident on the infrared camera 200. In this example, the condition of solar irradiation is a condition indicating whether or not the sunlight is directly made incident on the infrared camera 200 in the imaging position. The condition acquisition unit 146 obtains the position and the direction of the sun from the date and time of imaging. The threshold time setting unit 147 compares the traveling direction indicated by the positional information with the direction of the sun. The threshold time setting unit 147 determines whether or not the sunlight is directly made incident on the infrared camera 200.

When, for example, the positional relation is such that the sunlight is directly made incident on the infrared camera 200, the traveling direction is included within the determination range A. When the sun is included in the imaging direction of the infrared camera 200, the threshold time setting unit 147 sets the first threshold time TH1. When the positional relation is such that the sunlight is not directly made incident on the infrared camera 200, the traveling direction is not included in the determination range A. That is, since the sun is not included in the angle of view of the infrared camera 200, the protection determination unit 148 determines that the sunlight reflected by another object is made incident on the infrared camera 200. Accordingly, the threshold time setting unit 147 sets the second threshold time TH2 which is longer than the first threshold time TH1.

When the sun is included in the angle of view of the infrared camera 200, it is possible that the sunlight may be directly incident on the infrared camera 200. When the saturation time exceeds the first threshold time TH1, the protection determination unit 148 sets a protection flag. The instruction unit 142 sends an instruction to close the shutter 220. That is, when a pixel is saturated even in one frame, the shutter 220 is closed and the sensor 230 is quickly protected. Accordingly, the sensor 230 can be appropriately protected, and degradation of the infrared camera 200 can be suppressed.

Further, the threshold time setting unit 147 may specify the position and the region of the sun in the thermal image based on the positional information and the position of the sun. That is, the threshold time setting unit 147 specifies an assumed region in the thermal image where it is assumed that the sun is present in accordance with the imaging direction, the direction of the sun, and the like. Then, when pixels within the assumed region are saturated, the threshold time setting unit 147 sets the first threshold time TH1. When pixels other than the assumed region are saturated, the threshold time setting unit 147 sets the second threshold time TH2. Accordingly, it is possible to acquire thermal image data more appropriately.

When the sun is not included in the angle of view of the infrared camera 200, there is a low possibility that the sunlight is directly made incident on the sensor 230. That is, there is a high possibility that the sunlight reflected by another object is made incident on the infrared camera 200. In this case, the amount of the light received by the sensor 230 becomes lower than that in the case in which the sunlight is directly made incident on the sensor 230. When the saturation time exceeds the second threshold time TH2, the protection determination unit 148 sets a protection flag. The instruction unit 142 sends an instruction to close the shutter 220. That is, after the saturation is started and the saturation time exceeds the second threshold time TH2, the shutter 220 is closed. It is therefore possible to capture the thermal image data until the second threshold time is elapsed after the saturation is detected. As a result, the period during which images cannot be captured as the sunlight is made incident can be reduced.

### Second Embodiment

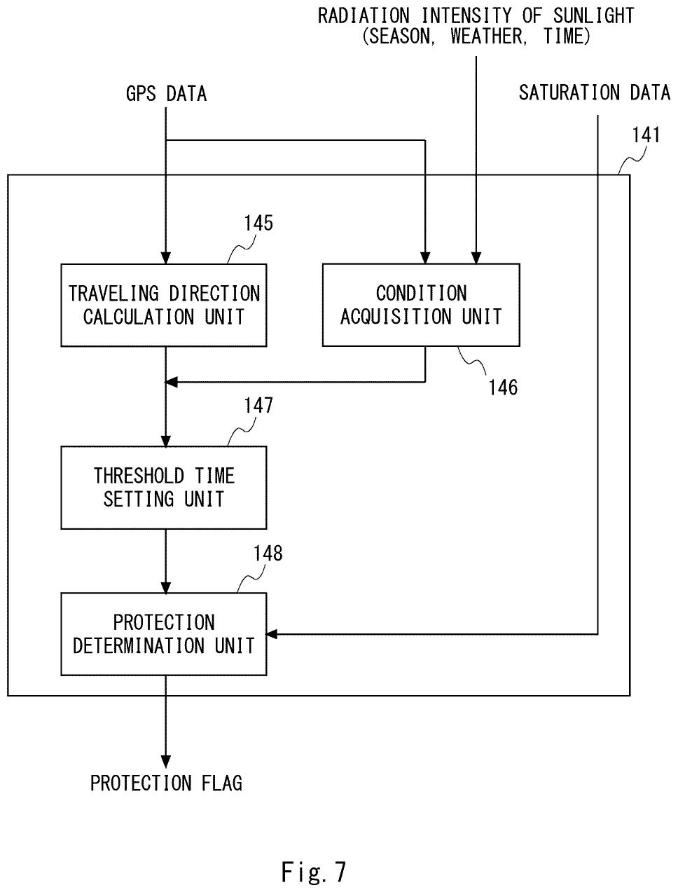

With reference to FIG. 7, an image processing apparatus according to this embodiment will be described. FIG. 7 is a control block diagram showing a configuration of a determination unit 141. In the second embodiment shown in FIG. 7, the processing in a condition acquisition unit 146 and a threshold time setting unit 147 is different from that in the first embodiment. Since the configurations and processing other than them are similar to those in the first embodiment, descriptions thereof will be omitted.

In this embodiment, the condition acquisition unit 146 acquires a condition of solar irradiation more finely. The condition acquisition unit 146 acquires a condition regarding a radiation intensity of sunlight. The threshold time setting unit 147 sets a threshold time finely according to a condition of the sunlight. The condition regarding the radiation intensity of the sunlight is a condition regarding the intensity of the sunlight that reaches the ground surface (infrared camera 200) from the sun. For example, the condition acquisition unit 146 acquires the condition such as the season, the weather, the time, and the like. For example, the intensity (energy) of the sunlight that is made incident on the infrared camera 200 varies due to the season, the weather, the time, or the like.

If it is sunny, the radiation intensity of the sunlight increases. On the other hand, if it is cloudy or rainy, the radiation intensity of the sunlight decreases. Since latitude and longitude can be known from GPS information, the condition acquisition unit 146 can acquire weather information or the like from internet information. When the time is close to noon, the radiation intensity of the sunlight increases. On the other hand, when the time is close to the sunrise or the sunset, the radiation intensity of the sunlight decreases. In winter, the radiation intensity of the sunlight increases than in summer.

The condition of solar irradiation can be divided more finely depending on the season, the weather, the time, and the like. For example, the threshold time setting unit 147 can divide the first threshold time TH1 more finely depending on the condition of the sunlight. Specifically, the threshold time setting unit 147 can set the first threshold time TH1 in five stages: 0, 1, 2, 3, and 4 seconds depending on the season, the weather, the time, and the like. As a matter of course, the number of stages in which the first threshold time TH1 is set may be any number equal to or greater than two.

Likewise, the threshold time setting unit 147 can divide the second threshold time TH2 more finely depending on the condition of the sunlight. Specifically, the threshold time setting unit 147 can set the second threshold time TH2 in five stages: 5, 6, 7, 8, and 9 seconds depending on the season, the weather, the time, and the like. As a matter of course, the number of stages in which the second threshold time TH2 is set may be any number equal to or greater than two.

Only one of the first threshold time TH1 and the second threshold time TH2 may be divided into stages. Further, the threshold time may be set using one of the season, the weather, and the time. Alternatively, the threshold time may be set using information other than the season, the weather, and the time. When it is known from GPS data that the vehicle is traveling in a tunnel, a multi-story parking lot, inside a building, underground or the like, the threshold time can be set longer since the sunlight is not directly made incident. The first threshold time TH1 and the second threshold time TH2 may partially overlap each other or may be completely separated from each other.

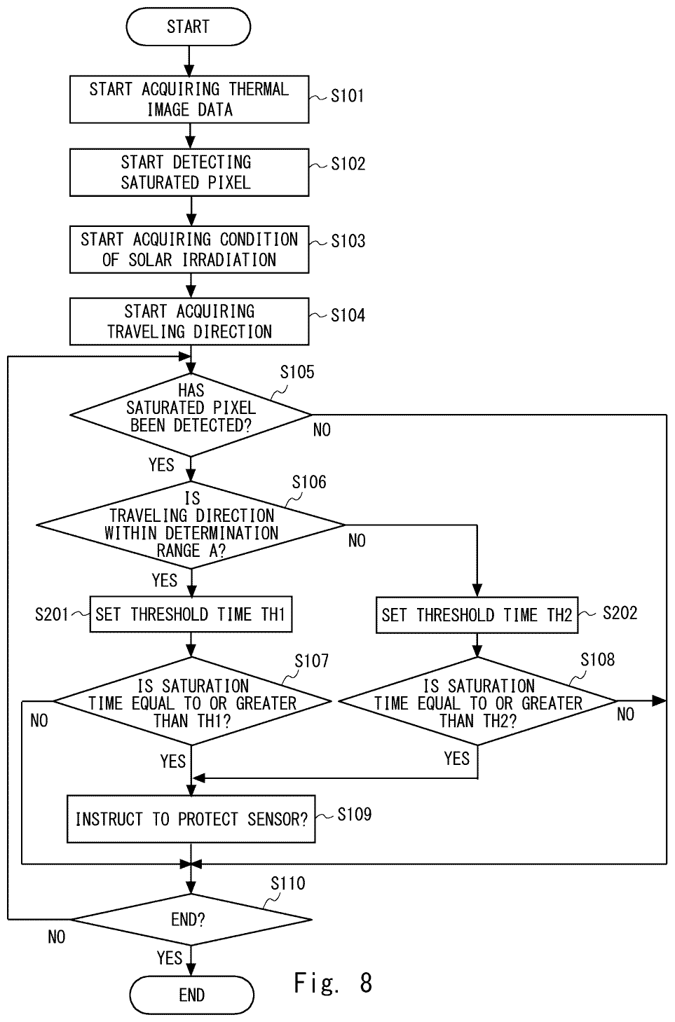

FIG. 8 is a flowchart showing an image processing method. The flowchart shown in FIG. 8 is different from the flowchart shown in FIG. 6 in that Steps S201 and S202 are added after Step S106 in FIG. 8. Since processing in FIG. 8 other than Steps S201 and S202 is similar to that in FIG. 6, descriptions thereof will be omitted.

When it is determined that the traveling direction of the own vehicle is within the determination range A (YES in Step S106), the threshold time setting unit 147 sets the first threshold time TH1 in accordance with the condition (Step S201). That is, the threshold time setting unit 147 sets the first threshold time TH1 in accordance with the intensity of the sunlight. Specifically, if it is sunny, winter, or close to noon, for example, the threshold time setting unit 147 sets the short first threshold time TH1. Specifically, if it is sunny, winter, or close to noon, for example, the threshold time setting unit 147 sets the short first threshold time TH1. If it is cloudy, summer, or close to sunrise or sunset, for example, the threshold time setting unit 147 sets the long first threshold time TH1. The protection determination unit 148 then compares the first threshold time with the saturation time (Step S107).

When it is not determined that the traveling direction of the own vehicle is within the determination range A (NO in Step S106), the threshold time setting unit 147 sets the second threshold time TH2 in accordance with the condition (Step S202). That is, the threshold time setting unit 147 sets the second threshold time TH2 in accordance with the intensity of the sunlight. Specifically, if it is sunny, winter, or close to noon, for example, the threshold time setting unit 147 sets the short second threshold time TH2. Specifically, if it is sunny, winter, or close to noon, for example, the threshold time setting unit 147 sets the short second threshold time TH2. If it is cloudy, summer, or close to sunrise or sunset, for example, the threshold time setting unit 147 sets the long second threshold time TH2. The protection determination unit 148 then compares the second threshold time TH2 with the saturation time (Step S108).

According to the above-described procedure, elements of the infrared camera 200 can be protected more appropriately. Further, even when saturation of a pixel has been detected, the period during which images can be captured can be increased. Note that the object on which the infrared camera 200 is mounted is not limited to a vehicle. That is, the infrared camera 200 is not limited to an in-vehicle camera. The infrared camera 200 may be, for example, a surveillance camera or the like installed in a facility.

### Third Embodiment

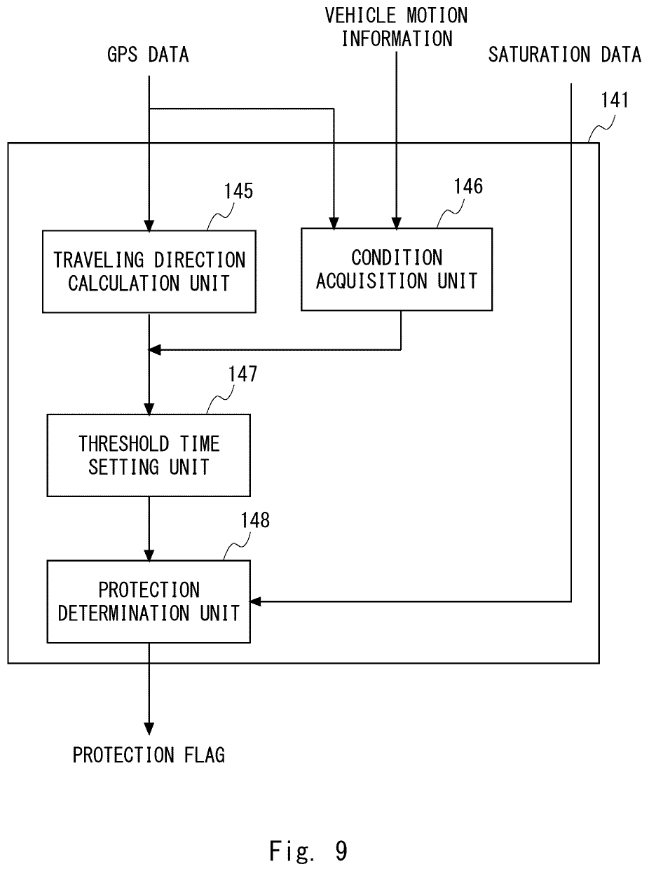

With reference to FIG. 9, an image processing apparatus according to this embodiment will be described. FIG. 9 is a control block diagram showing a configuration of a determination unit 141. The processing in a condition acquisition unit 146 and a threshold time setting unit 147 in the third embodiment shown in FIG. 9 is different from that in the first embodiment. Since the configurations and processing other than them are similar to those in the first embodiment, descriptions thereof will be omitted.

In this embodiment, the condition acquisition unit 146 acquires, besides a condition of solar irradiation in an imaging position, conditions under which positions where pixels are saturated due to sunlight move. Specifically, the condition acquisition unit 146 acquires a condition of solar irradiation in an imaging position, like in the first embodiment, and further acquires moving conditions based on motion information of a moving object such as a vehicle on which an infrared camera 200 is mounted. When the moving object is a vehicle, the condition acquisition unit 146 acquires vehicle speed information and steering information from a Controller Area Network (CAN) or the like of the vehicle as the motion information of the vehicle. The condition acquisition unit 146 may also acquire motion information from a smartphone or the like owned by a user.

The conditions under which the positions where pixels are saturated due to sunlight move are that the vehicle speed information indicates that the vehicle is traveling at a speed equal to or faster than a predetermined speed and the steering information indicates that the steering angle is equal to or greater than a predetermined steering angle. The predetermined speed is, for example, 5 km/h and the predetermined steering angle is, for example, at least 5-10°. That is, the condition acquisition unit 146 acquires, as the conditions under which the positions where pixels are saturated due to sunlight move, besides the condition that the vehicle speed information indicates that the vehicle speed is equal or faster than the predetermined speed, the condition that the steering information indicates that the steering angle is equal to or greater than the predetermined steering angle. As a matter of course, the predetermined speed and the predetermined steering angle indicating the conditions under which the positions where pixels are saturated due to sunlight move are not limited to the above-described values.

The conditions under which the positions where pixels are saturated due to sunlight move are, in other words, conditions that the time during which a particular pixel receives sunlight becomes relatively short since the imaging direction of the infrared camera 200 moves with respect to the sun due to the traveling and steering of the vehicle.

The threshold time setting unit 147 sets a threshold time based on the condition of solar irradiation and the conditions under which the positions where pixels are saturated due to sunlight move. When the conditions under which the positions where pixels are saturated due to sunlight move are not met in the state in which the imaging direction of the infrared camera is oriented toward the sun, the threshold time setting unit 147 sets a first threshold time as the threshold time. Further, when the conditions under which the positions where pixels are saturated due to sunlight move are met in the state in which the imaging direction of the infrared camera is oriented toward the sun, the threshold time setting unit 147 sets a second threshold time longer than the first threshold time.

Specifically, when the vehicle speed information indicates that the vehicle speed is equal to or higher than a predetermined speed and the steering information indicates that the steering angle is equal to or greater than a predetermined steering angle in the state in which the imaging direction of the infrared camera 200 is oriented toward the sun, the threshold time setting unit 147 determines that the conditions under which the positions where pixels are saturated due to sunlight move are met. On the other hand, when the vehicle speed information indicates that the vehicle speed is smaller than the predetermined speed or the steering information indicates that the steering angle is smaller than the predetermined steering angle, the threshold time setting unit 147 determines that the conditions under which the positions where pixels are saturated due to sunlight move are not met.

When the conditions under which the positions where pixels are saturated due to sunlight move are not met in the state in which the imaging direction of the infrared camera 200 is oriented toward the sun, the threshold time setting unit 147 sets the threshold time up to the protection of the sensor 230 to be a first threshold time TH1. Further, when the conditions under which the positions where pixels are saturated due to sunlight move are met in the state in which the imaging direction of the infrared camera 200 is oriented toward the sun, the threshold time setting unit 147 sets the threshold time up to the protection of the sensor 230 to be a second threshold time TH2.

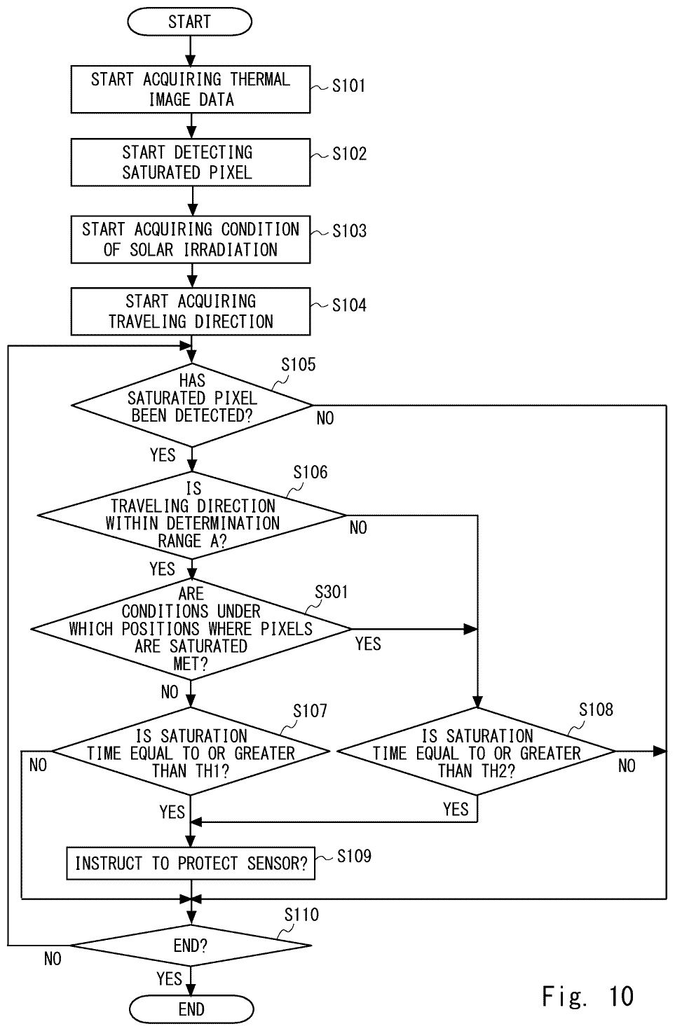

FIG. 10 is a flowchart showing an image processing method. Since the processing in FIG. 10 is similar to that in FIG. 6 except that Step S301 is performed, in FIG. 10, between Step S106 and Step S107 in the flowchart shown in FIG. 6, descriptions thereof will be omitted.

When a traveling direction of an own vehicle is within a determination range A (YES in Step S106), or in other words, when sunlight is directly made incident on the infrared camera 200, the threshold time setting unit 147 determines whether or not the conditions under which the positions where pixels are saturated due to sunlight move are met (Step S301).

When it is determined that the conditions under which the positions where pixels are saturated due to sunlight move are met (YES in Step S301), or in other words, when the vehicle is traveling at the predetermined speed or greater and the steering angle is equal to or greater than the predetermined steering angle, the protection determination unit 148 determines whether or not the saturation time is equal to or greater than the second threshold time TH2 (Step S108). That is, the threshold time setting unit 147 sets the second threshold time TH2 as the threshold time in the case where the traveling direction of the own vehicle is within the determination range A and the conditions under which the positions where pixels are saturated due to sunlight move are met.

When it is not determined that the conditions under which the positions where pixels are saturated due to sunlight move are met (NO in Step S301), or in other words, when the traveling speed of the vehicle is smaller than the predetermined speed or the steering angle is smaller than the predetermined steering angle, the protection determination unit 148 determines whether or not the saturation time is equal to or greater than the first threshold time TH1 (Step S107). That is, the threshold time setting unit 147 sets the first threshold time TH1 as the threshold time in the case where the traveling direction of the own vehicle is within the determination range A and the conditions under which the positions where pixels are saturated due to sunlight move are not met.

According to the aforementioned procedure, even in the case where the opening and closing of the shutter 220 are controlled in order to protect elements of the sensor 230 due to the sunlight being directly made incident on the infrared camera 200, the period until when the shutter is closed can be increased depending on the moving conditions of the vehicle, whereby it is possible to reduce the period during which the infrared camera 200 cannot capture images, or in other words, the period during which a person or the like corresponding to a heat source object cannot be detected, which occurs due to the shutter being closed more than necessary.

Further, a part or the whole of the processing in the above-described image processing apparatus 100 can be implemented as a computer program. This program can be stored and provided to a computer using any type of non-transitory computer readable media. Non-transitory computer readable media include any type of tangible storage media. Examples of non-transitory computer readable media include semiconductor memories (e.g., mask ROM, Programmable ROM (PROM), Erasable PROM (EPROM), flash ROM, or random access memory (RAM)). Further, the program(s) may be provided to a computer using any type of transitory computer readable media. Examples of computer readable media include electric signals, optical signals, and electromagnetic waves. Transitory computer readable media can provide the program to a computer via a wired communication line (e.g., electric wires, and optical fibers) or a wireless communication line.

Although embodiments of the invention made by the present inventors are specifically described in the foregoing, the present invention is not restricted to the above-described embodiments, and various changes and modifications may be made without departing from the scope of the invention. Two or more of the above-described embodiments may be combined as appropriate.

What is claimed is:

1. An image processing apparatus comprising:
a thermal image data acquisition unit configured to acquire thermal image data captured by an infrared camera;
a saturation detection unit configured to detect saturation of a pixel in the thermal image data;
a saturation time calculation unit configured to calculate a saturation time during which the pixel is successively saturated;
a positional information acquisition unit configured to acquire positional information regarding an imaging position of the infrared camera;
a condition acquisition unit configured to acquire a condition of solar irradiation in the imaging position;
a threshold time setting unit configured to set a threshold time in accordance with the condition of solar irradiation;
a protection determination unit configured to determine whether the saturation time has exceeded the threshold time; and
an instruction unit configured to send an instruction to close a shutter of the infrared camera in a case where the saturation time has exceeded the threshold time.

2. The image processing apparatus according to claim 1, wherein
the condition acquisition unit acquires a direction of the sun from the imaging position, and
the threshold time setting unit:
sets, when an imaging direction of the infrared camera is oriented toward the sun, a first threshold time as the threshold time; and
sets, when the imaging direction of the infrared camera is not oriented toward the sun, a second threshold time longer than the first threshold time as the threshold time.

3. The image processing apparatus according to claim 2, wherein
the positional information acquisition unit acquires positional information regarding a position and an orientation of an object on which the infrared camera is mounted, and
the threshold time setting unit calculates a determination range from the positional information and determines whether or not the imaging direction is included in a determination range.

4. The image processing apparatus according to claim 1, wherein
the condition acquisition unit acquires a condition regarding a radiation intensity of sunlight, and
the threshold time setting unit sets the threshold time in accordance with the condition regarding the radiation intensity of the sunlight.

5. The image processing apparatus according to claim 4, wherein
the condition acquisition unit acquires at least one of weather, season, and time as a condition regarding a radiation intensity of the sunlight, and
the threshold time setting unit sets the threshold time in accordance with at least one of the weather, the season, and the time.

6. The image processing apparatus according to claim 1, wherein
the condition acquisition unit acquires, besides a condition of solar irradiation in the imaging position, a condition under which the position where the pixel is saturated due to sunlight moves, and
the threshold time setting unit:
sets, in a case where the condition under which the position where the pixel is saturated due to the sunlight moves are not met in a state in which an imaging direction of the infrared camera is oriented toward the sun, a first threshold time as the threshold time; and
sets, in a case where the condition under which the position where the pixel is saturated due to the sunlight moves are met in a state in which the imaging direction of the infrared camera is oriented toward the sun, a second threshold time longer than the first threshold time.

7. The image processing apparatus according to claim 6, wherein the condition acquisition unit acquires, based on motion information of an object on which the infrared camera is mounted, the condition under which the position where the pixel is saturated due to the sunlight moves.

8. An image processing method comprising:
a step of acquiring thermal image data captured by an infrared camera;
a step of detecting saturation of a pixel in the thermal image data;
a step of acquiring positional information regarding an imaging position of the infrared camera;
a step of acquiring a condition of solar irradiation in the imaging position;
a step of setting a threshold time in accordance with the condition of solar irradiation;
a step of determining whether or not a saturation time during which the pixel is successively saturated has exceeded the threshold time; and
a step of sending an instruction to close a shutter of the infrared camera in a case where the saturation time has exceeded the threshold time.

9. A non-transitory computer readable medium storing a program for causing a computer to execute an image processing method,
wherein
the image processing method comprises:
a step of acquiring thermal image data captured by an infrared camera;
a step of detecting saturation of a pixel in the thermal image data;
a step of acquiring positional information regarding an imaging position of the infrared camera;
a step of acquiring a condition of solar irradiation in the imaging position;
a step of setting a threshold time in accordance with the condition of solar irradiation;
a step of determining whether or not a saturation time during which the pixel is successively saturated has exceeded the threshold time; and
a step of sending an instruction to close a shutter of the infrared camera in a case where the saturation time has exceeded the threshold time.
